(19) United States
(12) Patent Application Publication
(10) Pub. No.: US 2016/0153521 A1
(43) Pub. Date: Jun. 2, 2016

(54) DEVICE FOR DAMPING TORSIONAL OSCILLATIONS

(71) Applicant: VALEO EMBRAYAGES, Amiens Cedex (FR)

(72) Inventor: Clément TONDELLIER, Woincourt (FR)

(21) Appl. No.: 14/950,935

(22) Filed: Nov. 24, 2015

(30) Foreign Application Priority Data
Nov. 28, 2014 (FR) 1461664

(51) Int. Cl. F16F 15/14

(52) U.S. Cl. CPC F16F 15/145

(57) ABSTRACT

A device for damping torsional oscillations comprises a support rotationally displaceable around an axis. A pendulum body comprises first and second axially spaced movable masses. Each mass arranged on a side of the support. A member connects the first and second masses. A bearing interacts with a raceway defined by the support and at least one raceway defined by the pendulum body. An interposition part arranged to prevent contact in the axial direction between one of the masses and at least one of the rolling member and the support. The interposition part comprises an interposition region preventing occurrence of contact in the axial direction, and a region for fastening onto one of the masses or onto one of the rolling member and the support. The fastening region comprises at least two fastening tabs and a reinforcement connecting the tabs.

### CROSS-REFERENCE TO RELATED APPLICATIONS AND CLAIM TO PRIORITY

This application claims priority to Patent Application No. 1461664 filed Nov. 28, 2014 in France, the disclosure of which is incorporated herein by reference and to which priority is claimed.

### FIELD OF THE INVENTION

The present invention relates to a device for damping torsional oscillations, in particular for a motor vehicle transmission system.

### BACKGROUND OF THE INVENTION

In such an application, the device for damping torsional oscillations can be integrated into a torsion damping device of a clutch capable of selectively connecting the heat engine to the gearbox, in order to filter vibrations due to irregularities of the engine.

As a variant, in such an application the device for damping torsional oscillations can be integrated into a friction disk of the clutch or into a hydrodynamic torque converter.

A device of this kind for damping torsional oscillations conventionally utilizes a support and one or more pendulum bodies movable with respect to that support, the displacement of the pendulum bodies with respect to the support being guided by rolling members interacting on the one hand with raceways integral with the support, and on the other hand with raceways integral with the pendulum bodies. Each pendulum body comprises, for example, two pendulum masses riveted to one another.

Axial impacts can occur between the pendulum bodies and the support, or between the rolling members and the pendulum bodies. These impacts can result in premature wear on the aforementioned elements of the damping device and/or can generate undesired noise, especially when those elements are made of metal.

In order to prevent the occurrence of such impact, it is known, for example from the application DE 10 2006 028 556, to arrange shoes axially between the support and the pendulum masses of a pendulum body.

These shoes are subjected to large forces, which make them fragile and tend to damage them.

### SUMMARY OF THE INVENTION

There is a need to have available a device for damping torsional oscillations which exhibits axial shoes that are better adapted to the stresses applied thereonto.

The invention aims to meet that need, and according to one of its aspects does so with the aid of a device for damping torsional oscillations comprising:

a support capable of being displaced rotationally around an axis;

at least one pendulum body comprising: a first and a second pendulum mass spaced axially with respect to one another and movable with respect to the support, the first pendulum mass being arranged axially on a first side of the support and the second pendulum mass being arranged axially on a second side of the support; and at least one member connecting the first and the second pendulum mass and pairing said masses;

at least one rolling member interacting on the one hand with a raceway defined by the support and on the other hand with at least one raceway defined by the pendulum body, to guide the displacement of the pendulum body with respect to the support; and

at least one interposition part arranged so as to prevent the occurrence of contact in the axial direction between one of said pendulum masses and at least one among the rolling member and the support, the interposition part comprising:

an interposition region configured to prevent the occurrence of said contact in the axial direction; and

at least one region for fastening onto one of the pendulum masses or onto one among the rolling member and the support, the fastening region comprising at least two fastening tabs and a reinforcement connecting those two tabs.

The invention likewise relates to the above interposition part considered in isolation.

Thanks to the presence of the reinforcement, the fastening tabs of the fastening region have better resistance to the shear forces acting on the latter when the pendulum body is displaced with respect to the support. The service life of the interposition part, also called a “shoe,” can thus be extended.

The interposition part is made in particular of a damping material such as plastic or rubber.

The connecting member joins together the first and the second pendulum mass so that the pendulum mass forms a single integral assemblage.

For purposes of the present application:

“axially” means “parallel to the rotation axis of the support,”

“radially” means “along an axis belonging to a plane orthogonal to the rotation axis of the support and intersecting that rotation axis of the support,”

“angularly” or “circumferentially” means “around the rotation axis of the support,” and “integral” means “rigidly coupled.”

The fastening region can extend between an end emerging from the interposition region and a free end, each fastening tab extending between these ends. The fastening tabs can thus belong exclusively to the fastening region.

The reinforcement can extend over a length that is between 5% and 65%, in particular between 10% and 50%, in particular between 10% and 30% of the length of each fastening tab, that length being measured between the two ends of the fastening tab.

The reinforcement can connect the tabs at their end emerging from the interposition region. In this case the reinforcement can be a flange extending from the interposition region. The reinforcement can then allow the interposition part to be positioned appropriately on the element that carries it, in particular to center the interposition part on the element that carries it.

As a variant, the reinforcement can be arranged at a distance from the interposition region, being arranged, for example, at mid-length on the fastening tabs or in proximity to their free end.

The reinforcement can be implemented as a single part with the fastening tabs. The fastening region can then be implemented as a single part.

As a variant, the reinforcement is implemented from a material different from that used for the fastening tabs. The reinforcement can then be overmolded onto the fastening tabs.

Each fastening tab can comprise a hook for snap-locking the interposition part onto one of the pendulum masses or onto one among the support and the rolling member.

In a specific exemplifying embodiment of the invention, the fastening region comprises at least three tabs, and the reinforcement connects those three tabs two-by-two. The three tabs can succeed one another upon displacement around an axis, that axis in particular being parallel to the rotation axis of the support.

The reinforcement can then extend over 360° around that axis. As a variant, all the tabs can be connected two-by-two by the reinforcement, but the reinforcement does not extend over 360° around the axis.

The reinforcement can have a constant or variable length.

The interposition part can have another region for fastening onto one of the pendulum masses or onto one among the support and the rolling member, and that other fastening region can likewise have fastening tabs connected to one another by a reinforcement. The number of fastening tabs of this other fastening region can be less than the number of fastening tabs of the fastening region mentioned previously. This other fastening region comprises, for example, only two tabs similar to those described previously, and the reinforcement can then extend only 180° around the axis along which that other fastening portion of the interposition part globally extends.

In all of the above, the interposition part can be arranged so as to prevent the occurrence of contact in the axial direction between said pendulum mass and the support.

The interposition region also extends, for example, axially oppositely from a support portion in order to prevent the occurrence of that contact at least when the device is in the inactive position.

According to an embodiment of the invention, the raceway defined by the pendulum body is defined by the connecting member. This raceway can be constituted by part of the periphery of the connecting member, or by a coating deposited onto that part of the periphery of the connecting member. A connecting member of this kind is also called a “bearing spacer,” serving both to join to one another the pendulum masses of one pair and to participate in guiding the displacement of the pendulum body with respect to the support.

The connecting member can then be received in a window configured in the support, and part of the edge of that window can constitute the raceway defined by the support.

Two connecting members can then be provided in order to pair the first and the second pendulum mass, and those connecting members can then each be arranged in a separate window configured in the support.

Each connecting member can define a raceway interacting with a single rolling member.

According to this embodiment, there exist planes orthogonal to the rotation axis intersecting both a raceway defined by the pendulum body and a raceway defined by the support.

According to another embodiment of the invention, the pendulum body defines two raceways, one raceway being defined in the first pendulum mass and one raceway being defined in the second pendulum mass. The first and the second pendulum mass have, for example, a cavity receiving the rolling member, and an edge portion of that cavity constitutes the corresponding raceway. According to this other embodiment, that region of the rolling member which is arranged axially between the first and the second pendulum mass is received in a cavity of the support, that cavity being different from the window in which the connecting member is received. The rolling member can then comprise successively:

a region arranged in a cavity of the first pendulum mass and interacting with the raceway constituted by part of the edge of that cavity,

a region arranged in a cavity of the support and interacting with the raceway constituted by part of the edge of that cavity, and

a region arranged in a cavity of the second pendulum mass and interacting with the raceway constituted by part of the edge of that cavity.

According to this other embodiment, there may exist no plane orthogonal to the rotation axis of the support which intersects both a raceway defined by the support and a raceway defined by the pendulum body.

In all of the above, the interposition part can be carried by the support or else by the rolling member.

As a variant, in all of the above the interposition part can be carried by one among the first and the second pendulum mass.

When the interposition part is carried by one of the pendulum masses, the interposition region of the interposition part can comprise a receptacle interacting with an axial end of the rolling member during all or part of the displacement of the rolling member along the raceway defined by the pendulum body. In addition to reducing or even avoiding the axial impacts mentioned above, an interposition part of this kind then interacts with the rolling member during its displacement in order to guide that displacement. This interaction of the axial end of the rolling member with the receptacle can help retain the rolling member against the raceway defined by the pendulum body.

Again when the interposition part is carried by one of the pendulum masses, the interposition region of the interposition part can be arranged axially between said pendulum mass and the rolling member, and that interposition region can have a surface selected to prevent the occurrence of contact in the axial direction between the rolling member and said pendulum mass for several different positions of the rolling member along the raceway defined by the pendulum body. An interposition part of this kind thus ensures a non-zero axial gap between the rolling member and one of the pendulum masses during at least a portion of the displacement of the rolling member along the raceway defined by the pendulum body, in particular during the entirety of the displacement of the rolling member along the raceway defined by the pendulum body.

The shape of the interposition region can allow it to be interposed axially between the pendulum mass and the rolling member over the entire radial dimension of that rolling member when the latter rolls along the raceway defined by the pendulum body. In other words, in a plane orthogonal to the rotation axis of the support, the interposition region is arranged between the pendulum mass and the rolling member over the entire height of the latter.

If applicable, one of the pendulum masses carries several interposition parts, and only some of them have a receptacle as mentioned above and/or an interposition part whose surface is selected as mentioned above.

The first pendulum mass can carry at least one interposition part as described above, arranged so as to prevent the occurrence of contact in the axial direction between that first pendulum mass and at least one among the rolling member and the support; and the second pendulum mass can carry at least one interposition part as described above, arranged so as to prevent the occurrence of contact in the axial direction between that second pendulum mass and at least one among the rolling member and the support.

In all of the above:

the device for damping torsional oscillations has an inactive position in which the pendulum body is subjected to a centrifugal force but not to irregularities;

the device for damping torsional oscillations has a stop position of the pendulum body against the support, subsequent to a displacement in the trigonometric direction of the pendulum body with respect to the support from the inactive position; and

the device for damping torsional oscillations has a stop position of the pendulum body against the support, subsequent to a displacement in the non-trigonometric direction of the pendulum body with respect to the support from the inactive position.

Each connecting member can carry at least one stop damping member allowing damping of impacts associated with contacts existing between the connecting member and the support for at least one among the inactive position and the above stop positions.

The stop damping member can be a strip or a coating extending along part of the periphery of the connecting member, as disclosed e.g. in the application DE 10 2012 217 958. As a variant, the stop damping member can be as disclosed in the application filed in France on Oct. 14, 2014 under number 14 59836.

In all of the above, the pendulum body can comprise:

two connecting members, offset angularly and joining to one another the two pendulum masses of a pair; and

two stop damping members, each stop damping member being associated with one connecting member.

Two consecutive (in angular terms) support windows can then be associated with one pendulum body, each window receiving one of the connecting members, the associated stop damping member, and a rolling member.

In all of the above, the device can comprise:

at least one first pendulum body allowing a first order of the torsional oscillations to be filtered; and

at least one second pendulum body allowing a second order of the torsional oscillations, different from the first order, to be filtered.

For purposes of the present Application, an order of the torsional oscillations is filtered when the amplitude of that order of the torsional oscillations is reduced by the device by a value equal to at least 10% of the amplitude before filtering.

Since the device is configured to filter orders, the frequency of the torsional oscillations filtered respectively by the first and the second pendulum body varies as a function of the rotation speed of the support. The use of the term “order” implies that variable frequencies are involved.

In all of the above, each rolling member is, for example, a roller circular in section in said plane orthogonal to the rotation axis of the support. The axial ends of the roller can be devoid of a thin annular flange. The roller is made, for example, of steel.

In all of the above, the shape of the raceways can be such that the pendulum bodies are displaced with respect to the support only in translation around a notional axis parallel to the rotation axis of the support.

As a variant, the shape of the raceways can be such that the pendulum bodies are displaced with respect to the support

both in translation around a notional axis parallel to the rotation axis of the support,

and also rotationally around the center of gravity of said pendulum body, such a motion also being called a “combined motion” and being disclosed, for example, in the Application DE 10 2011 086 532.

In all of the above, each rolling member can be loaded only in compression between the raceway defined by the support and the raceway defined by the pendulum body.

In all of the above, the support can be made, or not, as a single part.

The device comprises, for example, several pendulum bodies, for example a number between two and eight, in particular three or six pendulum bodies. The pendulum bodies can then succeed one another around the rotation axis of the support. All the pendulum bodies can be received in the same axial space.

A further object of the invention, according to another of its aspects, is a component for a transmission system of a motor vehicle, the component being in particular a dual mass flywheel, a hydrodynamic torque converter, or a friction disk, comprising a device as defined above for damping torsional oscillations.

The support of the device for damping torsion oscillations can then be one among:

a flange of the component,

a guide washer of the component,

a phase washer of the component, or

a support different from said flange, from said guide washer, and from said phase washer.

### BRIEF DESCRIPTION OF THE DRAWINGS

A better understanding of the invention may be gained from reading the description below of non-limiting exemplifying embodiments thereof, and from an examination of the attached drawings, in which:

FIG. 1 schematically depicts a torsion damping device into which interposition parts according to the invention can be integrated;

FIG. 2 is a detail of the device of FIG. 1 into which interposition parts according to an exemplifying embodiment of the invention are integrated, the device here being inactive;

FIG. 3 depicts a detail of FIG. 2;

FIG. 4 is a view similar to FIG. 2, the device in this case being in a stop position against the support subsequent to a displacement from the inactive position;

FIG. 5 depicts a detail of FIG. 4;

FIG. 6 is a view of FIG. 2 in section along VI-VI;

FIG. 7 depicts in isolation one of the interposition parts visible in FIG.

2;

FIG. 8 is a section view, in a plane containing the rotation axis of the device, of the interposition part when it is carried by one of the pendulum masses of the pendulum body of the device; and

FIG. 9 is a partial view of another example of a device for damping torsional oscillations into which interposition parts according to the invention can be integrated.

### DETAILED DESCRIPTION OF THE PREFERRED EMBODIMENT(S)

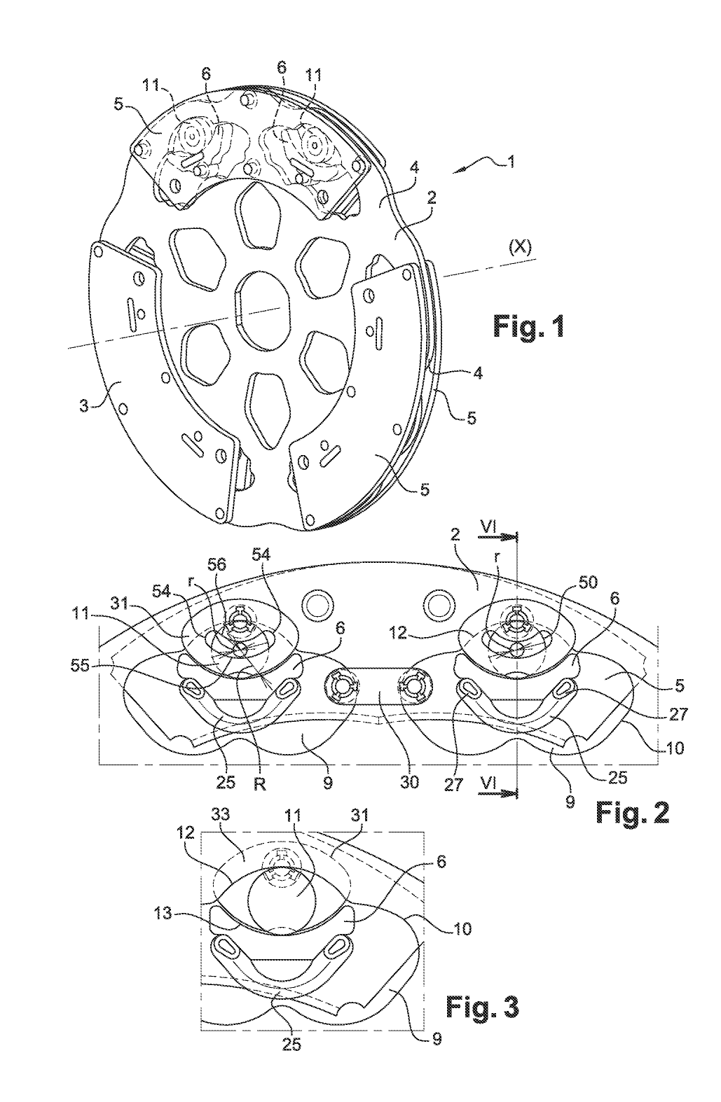

FIG. 1 depicts a damping device 1 into which one or more interposition parts according to the invention can be integrated. These interposition parts are also called “shoes.” Damping device 1 is of the pendulum oscillator type. Device 1 is, in particular, capable of being part of a motor vehicle transmission system, for example being integrated into a component (not depicted) of such a transmission system, that component being, for example, a dual mass flywheel, a hydrodynamic torque converter, or a friction disk.

This component can form part of a drive train of a motor vehicle, the latter comprising a heat engine having, in particular, three or four cylinders.

In FIGS. 1 to 3, device 1 is inactive. In known fashion, a component of this kind can comprise a torsion damper having at least one input element, at least one output element, and circumferentially acting elastic return members that are interposed between said input elements and output elements. For purposes of the present Application, the terms “input” and “output” are defined with respect to the direction of torque transmission from the heat engine of the vehicle to the wheels of the latter.

In the example considered, device 1 comprises:

a support 2 capable of being displaced rotationally around an axis X; and

a plurality of pendulum bodies 3 that are movable with respect to support 2.

In the example considered, three pendulum bodies 3 are provided, being distributed uniformly over the periphery of axis X.

Support 2 of damping device 1 can be constituted by:

an input element of the torsion damper;

an output element or an intermediate phasing element arranged between two series of springs of the damper; or

an element rotationally connected to one of the aforementioned elements and different from the latter, being then, for example, a support specific to device 1.

Support 2 is, in particular, a guide washer or a phase washer.

In the example considered, support 2 is globally in the shape of a ring having two opposite sides 4 that here are planar faces.

As is evident in particular from FIG. 1, in the example considered each pendulum body 3 comprises:

two pendulum masses 5, each pendulum mass 5 extending axially oppositely from a side 4 of support 2; and

two connecting members 6 joining the two pendulum masses 5.

In the example considered, connecting members 6, also called “spacers,” are offset angularly.

Each connecting member 6 extends partly in a window 9 configured in the support. In the example considered, window 9 defines an empty space inside the support, that window being delimited by a closed periphery 10.

In the example considered, device 1 also comprises rolling members 11 that guide the displacement of pendulum bodies 3 with respect to support 2. Rolling members 11 here are rollers, at least a region of which has a circular cross section of radius R.

In the example described, the motion of each pendulum body 3 with respect to support 2 is guided by two rolling members 11, each of them interacting with one of connecting members 6 of pendulum body 3.

Each rolling member 11 interacts on the one hand with a raceway 12 that is defined by support 2 and is constituted here by a portion of periphery 10 of window 9, and on the other hand with a raceway 13 that is defined by pendulum body 3 and is constituted here by a portion of the outer periphery of connecting member 6.

More specifically, each rolling member 11 interacts, during its displacement with respect to support 2 and pendulum body 3, at a radially internal level with raceway 13 and at a radially external level with raceway 12, for example being loaded only in compression between raceways 12 and 13. In the example described, as depicted e.g. in FIG. 3, raceways 12 and 13 have portions radially opposite one another.

In the examples considered, device 1 comprises stop damping members 25. Each connecting member 6 carries, for example, one stop damping member 25.

As depicted in FIG. 1, these stop damping members 25 can be as described in the application filed in France on Oct. 14, 2014 under the number 14 59836. As a variant, these stop damping members 25 can be in the form of a lining surrounding, in a plane orthogonal to the rotation axis, a portion of the periphery of connecting member 6, as depicted in FIGS. 2 to 5. A stop damping member 25 of this kind can have axial rods 27 whose ends are received in one of pendulum masses 5, in order to join that stop damping member 25 to the pendulum masses of a pendulum body 3.

These stop damping members 25 allow damping of the impacts associated with pendulum body 3 coming to a stop against support 2 subsequently to a displacement from the inactive position, regardless of the direction of that displacement. A displacement of this kind occurs in planes orthogonal to rotation axis X, and not axially. Stop damping members 25 can furthermore allow damping of impacts associated with radial falling of pendulum body 3 at low rotation speeds of the vehicle's heat engine, for example when the vehicle is started or at a standstill.

Device 1 comprises interposition parts 30 and 31 that will now be described. Each interposition part 30 or 31 is, in particular, implemented from a damping material such as plastic or rubber.

In the example considered, interposition parts 30 and 31 are carried by a pendulum mass 5, and each pendulum mass 5 of a pendulum body 3 carries interposition parts 30 and 31.

In the example considered, each interposition part 30 or 31 is arranged so as to prevent the occurrence of contact in the axial direction, i.e. along axis X, between pendulum mass 5 that carries it and support 2. As depicted more clearly in FIGS. 7 and 8, each interposition part 30 or 31 comprises:

an interposition region 33 configured to prevent the occurrence of that contact along axis X; and

at least one region 34 for fastening onto pendulum mass 5. In the examples considered, this fastening region 34 comprises three fastening tabs 36 that extend globally around an axis Y parallel to axis X, between an end 39 arising at the level of interposition region 33 and a free end 40 that allows fastening onto pendulum mass 5. In the example considered, each free end 40 constitutes a hook for snap-locking fastening tab 36 onto pendulum mass 5.

In the examples considered, a cutout 42 is configured in interposition region 33, radially opposite each fastening tab 36 and radially externally from that tab 36 with respect to axis Y.

Again in the examples considered, a reinforcement 45 connects fastening tabs 36 two-by-two. In the examples described, the reinforcement is configured all around axis Y and is constituted by a rim extending along a portion of fastening tabs 36 from interposition region 33. Reinforcement 45 here has a constant length all around axis Y.

Reinforcement 45 can impart to interposition parts 30 or 31 better resistance to the shear forces acting on the latter during the displacement of pendulum body 3 with respect to support 2. In addition, as is evident in particular from FIG. 8, reinforcement 45 can allow centering of interposition part 30 or 31 in the hole configured in pendulum mass 5 in order to receive fastening region 34.

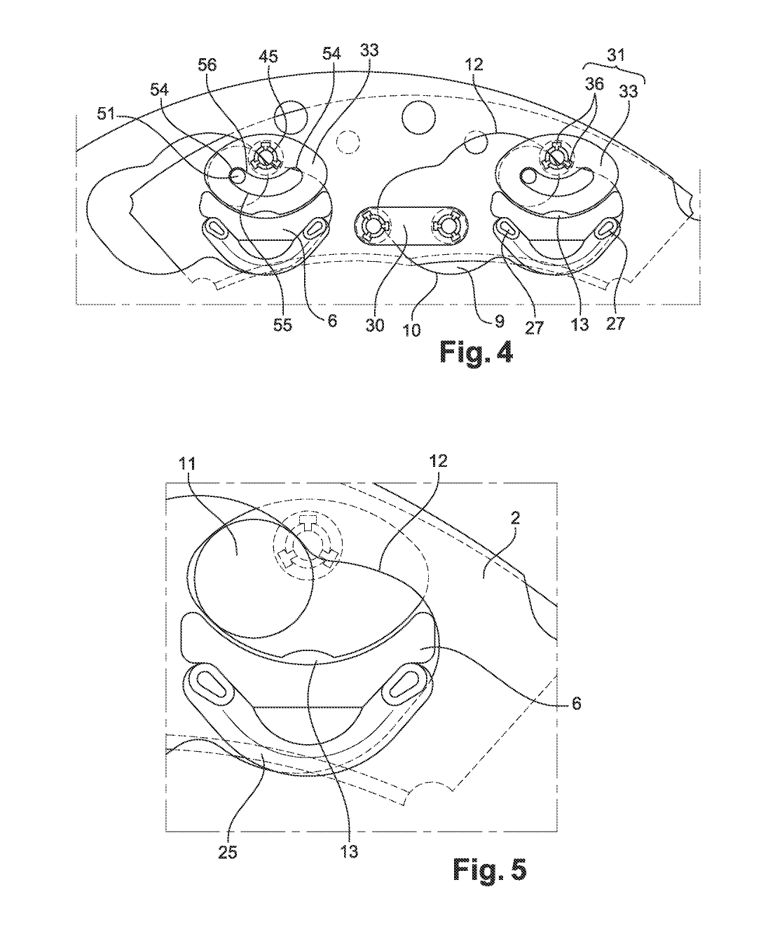

As depicted in FIGS. 2 and 4, a pendulum mass 5 carries, for example, only a single interposition part 30, and the latter can be arranged on pendulum mass 5 substantially at half the distance between the angular ends of that pendulum mass 5. The position of this interposition part 30 can be selected so that the latter is always at least in part axially opposite support 2, in order to prevent axial impacts between that support 2 and that pendulum mass 5.

In the example considered, each interposition part 30 and each interposition part 31 has two fastening regions 34.

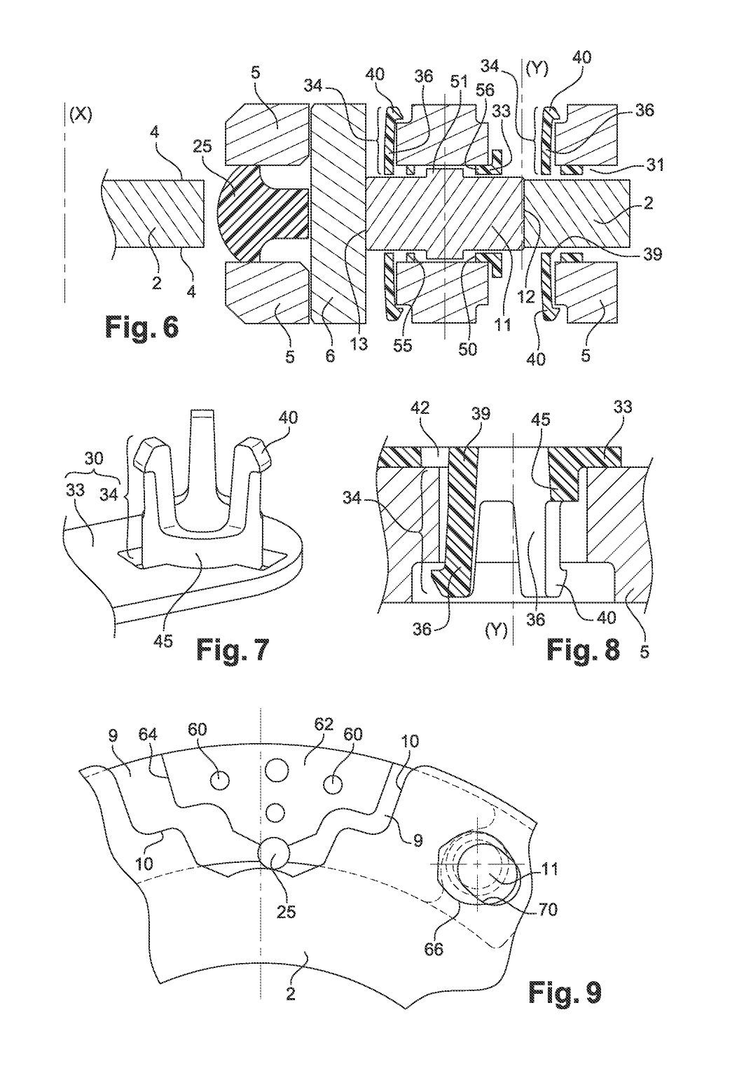

Interposition parts 31 will now be described. They differ from interposition parts 30 in terms of the number thereof on a single pendulum mass 5, in terms of the shape of their interposition region 33, and by the fact that they can interact with an axial end 51 of a rolling member 11 associated with pendulum body 3. It is evident from FIG. 6 that the two fastening regions 34 of a single interposition part 31 are different. The one of fastening regions 34 that is radially outermost is similar to the one previously described. The other fastening region 34, which is radially innermost, here has only two fastening tabs 36, and it is configured directly radially opposite raceway 13 defined by connecting member 6.

In the example considered, each interposition part 31 is associated with a connecting member 6 of pendulum mass 3, and it has an interposition region 33 arranged axially between pendulum mass 5 that carries it, and rolling member 11. The surface area of this interposition region 33 is sufficient here to prevent the occurrence of contact in the axial direction between rolling member 11 and that pendulum mass 5, for all positions of rolling member 11 along raceway 13 defined by connecting member 6. Thus, whether pendulum mass 3 is:

in an inactive position when device 1 for damping torsional oscillations is inactive, as depicted in FIGS. 2 and 3;

in a stop position against support 2 subsequent to the displacement of pendulum body 3 from the inactive position, as depicted in FIGS. 4 and 5; or

in any position intermediate between these positions,

region 33 of the interposition part comes between rolling member 11 and said pendulum mass 5 in order to prevent the occurrence of contact along axis X between those parts 11 and 5.

As depicted in FIGS. 2 to 5, interposition region 33 has in the plane of the Figures, for example, a surface whose external periphery is substantially in the shape of an ellipse.

Interposition region 33 extends, for example, radially externally with respect to raceway 13 defined by connecting member 6, and a portion of the external periphery of that interposition region 33 can be directly opposite all of raceway 13. This portion of the external periphery of interposition region 33 has, for example, the same shape as the shape of raceway 13.

Interposition region 33 that has just been described can also have a surface allowing it to become permanently interposed axially between support 2 and pendulum mass 5 that carries it.

As is evident from FIGS. 2, 4, and 6, each interposition region 33 can furthermore comprise a receptacle 50 that interacts with an axial end 51 of rolling member 11 during the displacement of rolling member 11 along raceway 13 defined by connecting member 6.

Each axial end 51 of rolling member 11 defines, for example, a peg having a radius r smaller than the radius R of the remainder of rolling member 11, and that peg 51 slides in receptacle 50 during the displacement of rolling member 11 along raceway 13 defined by connecting member 6.

In the example considered, receptacle 50 is a through hole; it extends between two angular ends 54 and is radially delimited by a radially internal edge 55 and by a radially external edge 56.

As is evident from FIGS. 4 and 5, when pendulum 3 is at a stop against support 2, peg 51 can then be at a stop against one of angular ends 54 of receptacle 50.

Interposition parts 31 can also be different.

Interposition region 33 can have a surface allowing it to become axially interposed, between rolling member 11 and pendulum mass 5 that carries that interposition part, only in certain positions of rolling member 11 along raceway 13 defined by connecting member 6. Raceway 13 has a length, measured along said raceway, between the location on the raceway with which rolling member 11 interacts when device 1 is inactive and the location on said raceway with which rolling member 11 interacts when pendulum body 3 is in a stop position subsequent to the displacement thereof from its inactive position. The surface of interposition region 33 of interposition part 31 can allow the occurrence of contact along axis X to be prevented only when rolling member 11 is displaced along a portion of raceway 13 whose length is equal to 50%, for example, of the length of raceway 13.

Receptacle 50 can interact with peg 51 during only a portion of the displacement of rolling member 11 along raceway 13 defined by connecting member 6.

Another device 1 into which interposition parts 30 and/or 31 as described above can be integrated will now be described with reference to FIG. 9.

This second example differs from the one described with reference to FIGS. 1 to 8 by the fact that pendulum body 3 and support 2 have a different structure.

Window 9 here is open radially outward, and periphery 10 thus does not define a closed line.

In the example of FIG. 9, the two pendulum masses 5 are connected via a plurality of rivets 60 that are received in a guidance part 62. As is evident from FIG. 8, this guidance part 62 has angular edges 64 whose shape can interact with that of periphery 10 of opening 9 in order to constitute a stop for the displacement of pendulum body 3 with respect to support 2.

In this example, cavities 66 different from window 9 are configured in support 2 and are substantially axially opposite other cavities 70 configured in pendulum masses 5. Each rolling member 11 is received both in a cavity 66 and in a cavity 70, in order to guide the displacement of pendulum body 3 with respect to support 2.

The invention is not limited to the examples that have just been described. The foregoing description of the exemplary embodiment(s) of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A device (1) for damping torsional oscillations, comprising:
a support (2) capable of being displaced rotationally around an axis (X);
at least one pendulum body (3) comprising: a first and a second pendulum mass (5) spaced axially with respect to one another and movable with respect to the support (2), the first pendulum mass (5) being arranged axially on a first side (4) of the support (2) and the second pendulum mass (5) being arranged axially on a second side (4) of the support (2); and at least one member (6) connecting the first and the second pendulum mass (5) and pairing said masses;
at least one rolling member (11) interacting on the one hand with a raceway (12) defined by the support (2) and on the other hand with at least one raceway (13) defined by the pendulum body (3), to guide the displacement of the pendulum body (3) with respect to the support (2); and
at least one interposition part (30, 31), arranged so as to prevent the occurrence of contact in the axial direction (X) between one of said pendulum masses (5) and at least one among the rolling member (11) and the support (2),
the interposition part (30, 31) comprising:
an interposition region (33) configured to prevent the occurrence of said contact in the axial direction (X); and
at least one region (34) for fastening onto one of the pendulum masses (5) or onto one among the rolling member (11) and the support (2), the fastening region (34) comprising at least two fastening tabs (36) and a reinforcement (45) connecting those two tabs (36).

2. The device according to claim 1, the fastening region (34) extending between an end (39) emerging from the interposition region (33) and a free end (40), each fastening tab (36) extending between these ends (39, 40).

3. The device according to claim 2, the reinforcement (45) extending over a length that is between 5% and 65%, in particular between 10% and 50% of the length measured between its two ends (39, 40) of each fastening tab (36).

4. The device according to claim 2, the reinforcement (45) connecting the tabs (36) at their end (39) emerging from the interposition region (33).

5. The device according to claim 4, the reinforcement (45) being a flange extending from the interposition region (33).

6. The device according to claim 1, each fastening tab (36) comprising a hook for snap-locking the interposition part (30, 31) onto one of the pendulum masses (5) or onto one among the support (2) and the rolling member (11).

7. The device according to claim 1, the fastening region (34) comprising at least three tabs (36), and the reinforcement (45) connecting those three tabs (36) two-by-two.

8. The device according to claim 1, the raceway (13) defined by the pendulum body (3) being defined by the connecting member (6).

9. The device according to claim 1, the interposition part (30, 31) being carried by one among the first and the second pendulum mass (5).

10. The device according to claim 9, the interposition region (33) of the interposition part (31) comprising a receptacle (50) interacting with an axial end (51) of the rolling member (11) during all or part of the displacement of the rolling member (11) along the raceway (13) defined by the pendulum body (3).

11. The device according to claim 9, the interposition region (33) of the interposition part (31) being arranged axially between said pendulum mass (5) and the rolling member (11), and that interposition region (31) having a surface selected to prevent the occurrence of contact in the axial direction (X) between the rolling member (11) and said pendulum mass (5) for several different positions of the rolling member (11) along the raceway (13) defined by the pendulum body (3).

12. The device according to claim 9, the first pendulum mass (5) carrying at least one interposition part (30, 31) arranged so as to prevent the occurrence of contact in the axial direction (X) between that first pendulum mass (5) and at least one among the rolling member (11) and the support (2); and the second pendulum mass (5) carrying at least one interposition part (30, 31) arranged so as to prevent the occurrence of contact in the axial direction (X) between that second pendulum mass (5) and at least one among the rolling member (11) and the support (2).

13. A component for a transmission system of a motor vehicle, the component being in particular a dual mass flywheel, a hydrodynamic torque converter, or a friction disk, comprising a damping device (1) according to claim 1.

14. The component according to claim 13, the support (2) of the device being one among:
a flange of the component,
a guide washer of the component,
a phase washer of the component, or
a support different from said flange, from said guide washer, and from said phase washer.

15. The device according to claim 3, the reinforcement (45) connecting the tabs (36) at their end (39) emerging from the interposition region (33).

16. The device according to claim 2, each fastening tab (36) comprising a hook for snap-locking the interposition part (30, 31) onto one of the pendulum masses (5) or onto one among the support (2) and the rolling member (11).

17. The device according to claim 3, each fastening tab (36) comprising a hook for snap-locking the interposition part (30, 31) onto one of the pendulum masses (5) or onto one among the support (2) and the rolling member (11).

18. The device according to claim 4, each fastening tab (36) comprising a hook for snap-locking the interposition part (30, 31) onto one of the pendulum masses (5) or onto one among the support (2) and the rolling member (11).

19. The device according to claim 5, each fastening tab (36) comprising a hook for snap-locking the interposition part (30, 31) onto one of the pendulum masses (5) or onto one among the support (2) and the rolling member (11).

20. Interposition part (30, 31), arranged so as to prevent the occurrence of contact in the axial direction (X) between a pendulum mass (5) and at least one among a rolling member (11) and a support (2) of a device (1) for damping torsional oscillations, the interposition part (30, 31) comprising:
an interposition region (33) configured to prevent the occurrence of said contact in the axial direction (X); and
at least one region (34) for being fastened onto the pendulum mass (5) or onto one among the rolling member (11) and the support (2), the fastening region (34) comprising at least two fastening tabs (36) and a reinforcement (45) connecting those two tabs (36).
